(19) United States
(12) Patent Application Publication
(10) Pub. No.: US 2025/0377474 A1
(43) Pub. Date: Dec. 11, 2025

(54) COIL FOR MULTI-FREQUENCY METAL DETECTOR

(71) Applicant: DETECH Ltd, Shumen (BG)

(72) Inventor: Rumen Denchev KUNEV, Shumen (BG)

(21) Appl. No.: 18/860,976

(22) PCT Filed: Aug. 12, 2022
(86) PCT No.: PCT/BG2022/000010

§ 371 Date: Oct. 28, 2024

(30) Foreign Application Priority Data
Apr. 3, 2022 (BG) 5507

(51) Int. Cl. G01V 3/10

(52) U.S. Cl. CPC G01V 3/10

(57) ABSTRACT

The invention relates to a coil for multi-frequency metal detector, which is used to detect metal objects, located deep in the ground or other places, and has applications in the fields of archaeology, geology, construction, military and police practice, etc. The coil works equally effectively at both high and low frequencies, in the range of 500 Hz-100 KHz. As a result of the joint action of the three coils housed in one housing, the coil multi-frequency detector has a high sensitivity to small metal targets and optimal depth operation for the detection of large metal targets. It consists of housing (1), in which mutually balanced transmitter (2), main receiver (3) and additional receiver (4) coils are placed. The transmitting coil (2) and the main receiving coil (3), which are made in the shape of the Latin letter D, with the radius of curvature identical to the outer surface of the housing (1).

### FIELD OF THE INVENTION

The invention refers to a coil for multi-frequency metal detector, which is used to detect metal objects located deep in the ground or elsewhere and is used in the field of archeology, geology, construction, military and police practice and etc.

### BACKGROUND OF THE INVENTION

The coil is a component of a device for detecting metal objects-metal detector, which are located in the ground. As such objects are of different sizes and can be located at different depth, the metal detectors must be properly designed and adjusted to ensure the necessary efficiency.

There are various designs of metal detector coils, consisting of a housing in which one transmitter and one receiver coil are placed, located in one or parallel planes, touching and partially overlapping. As a rule, the shape of the housing is chosen and implemented in such a way as to ensure an inductive balance between the transmitting and the receiving coil.

The disadvantage of this coil is that all frequencies transmitted by the transmitting coil are received by the same receiving coil, which is made of the same size.

Multi-frequency detectors, when operating at high frequencies, have better sensitivity for small metal targets and work optimally with small size coils. When working with large search coils, especially on heavy and moist soils, negative results are obtained: parasitic signals from the soil; parasitic signals, which are reaction from the electromagnetic field of the earth; parasitic signals when passing over a hole in the ground.

Multi-frequency detectors must be equipped with small sized search coils in order to work optimally and correctly at high frequencies.

The advantage of multi-frequency detectors when operating at low frequencies is that they have a very good depth for larger metal targets.

They work with large search coils without the following negative reactions: parasitic signals from the soil; parasitic signals from the soil; parasitic signals, which are reaction from the electromagnetic field of the earth; parasitic signals when passing over a hole in the ground.

Disadvantage of multi-frequency detectors operating at low frequencies with large search coils is that they have no sensitivity to small metal targets.

### SUMMARY OF THE INVENTION

The purpose of the invention is to offer a search coil for multi-frequency metal detector, which provides efficient operation in detecting metal objects characterized by high sensitivity and depth in detecting small and large objects and to combine all the advantages of multi-frequency detectors operating simultaneously at low frequencies and at high frequencies

The aim is solved by a search coil for multi-frequency metal detector, consisting of a housing, with a transmission coil and a main receiving coil, made in the shape of the latin letter D and located in parallel planes, with partial overlap of the two coils and are in inductive balance.

According to the invention, an additional receiving coil is placed in the housing, the two receiving coils are lying in one plane, the additional receiving coil is smaller than the main receiving coil, having a shape identical to the shape of the main receiving coil and both of the receiving coils are in inductive balance with the transmitting coil.

Structurally, the receiving coils can be located in different ways—to lie in different planes, to be in contact with each other or to be located at a distance of not more than 100 mm from each other.

In one variant of invention the search coil, the receiving coils can be from 2 to 6 pcs.

The transmission coils can be from 1 to 3 pcs.

According to one preferred embodiment of the search coil, the transmission coils are made of spirally shaped windings.

The housing of the search coil can be made in the shape of a circle, ellipse, rhombus, square or other polygon, with dimensions from 100 to 2000 mm.

The search coil can work with a metal detector operating at frequencies from 2 to 200 pcs. of frequencies.

The shape of the coils can be in the shape of the Latin letter D, ellipse, circle, rhombus or polygon.

The operating frequency of the search coil is from 500 Hz to 100 kHz.

According to a variant implementation of the antenna, the transmission coils can be 2 or 3 pieces of the same size and shape, located on top of each other as they are touching or at a distance of up to 100 mm from each other.

According to another variant embodiment of the antenna, the transmission coils can be from 2 to 6 pieces, located one inside the other, lying in one plane or in parallel planes at a distance of up to 100 mm from each other.

The search coil, object of the invention, is constructed in such a way that it allows the creation of larger search coils, which will work equally efficiently at both high and low frequency. The advantage of a multi-frequency detector operating with such a search coil is that the design of the utility model is made of two, differently sized, simultaneously operating search coils, respectively one of the coils works with the main receiving coil for low frequencies from 500 Hz to 10 kHz, and the other one works with the additional receiving coil for high frequencies from 10 kHz to 100 kHz.

The inclusion of the auxiliary receiving coil ensures the capture of signals from the high frequency range, as the main and larger receiving coil receives the signals from the low frequencies. As a result of the combined action of the three coils placed in one housing, the multi-frequency detector search coil has a high sensitivity to small metal targets and optimal depth operation for detecting large metal targets. The proposed search coil effectively combines the advantages of small-sized search coils and large-sized search coils, working in practice.

### DESCRIPTION OF THE DRAWINGS

Further in the description is presented an exemplary embodiment of a search coil with a multi-frequency metal detector, object of the invention, which is illustrated in detail with the help of the attached drawings, where:

FIG. 1—search coil housing for a multi-frequency detector, known from the prior art

FIG. 2—shows the mutual arrangement of transmitting and receiving coils placed in the housing of FIG. 1

FIG. 3—shows the housing of a search coil for a multi-frequency metal detector according to the invention.

FIG. 4—shows a search coil housing for a multi-frequency metal detector according to the invention, in which are placed a transmission coil, main and additional receiving coils.

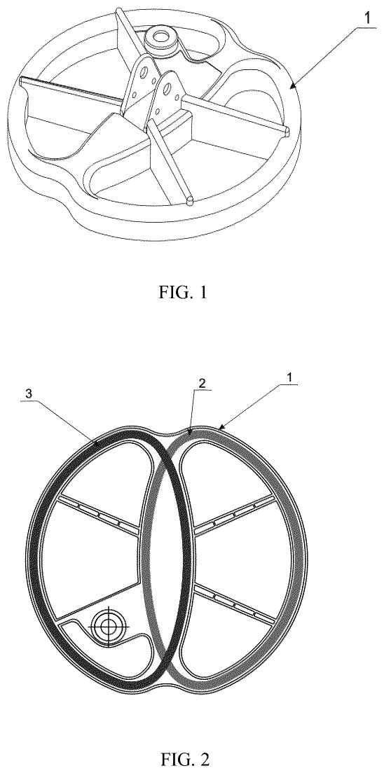

### EXAMPLE IMPLEMENTATION OF THE INVENTION

An exemplary embodiment of a metal detector search coil according to the invention is presented in more detail by means of a detailed description and with reference to the accompanying drawings. It will be easy for specialists in that field to accept and evaluate that the present exemplary description is for the purpose of clarifying the idea of the proposed search coil design, and the scope of protection of the invention goes beyond this exemplary embodiment.

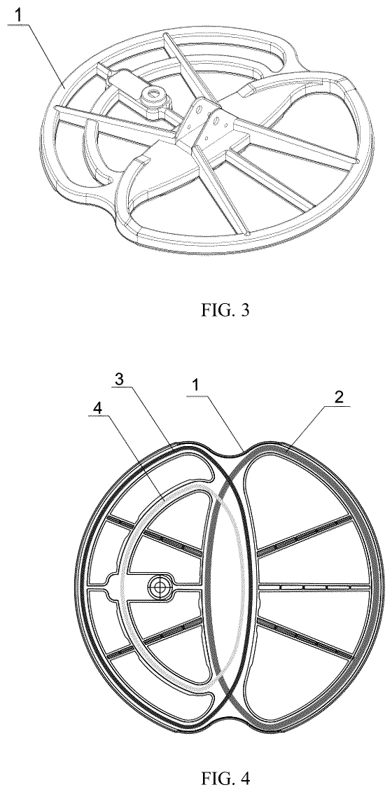

A preferred embodiment of the search coil according to the invention is shown in FIG. 3, which consists of a housing 1, in which are placed balanced transmission coil 2, main receiving coil 3 and additional receiving coil 4.

The housing 1 (FIG. 3) is made of a paired kidney shape, preferably of polymer or similar material, with an external size of 350 mm. and the arched peripheral walls form a bed for the transmission coil 2 and the main receiving coil 3, which are in the shape of the Latin letter D, and the radius of curvature is identical to the outer surface of the housing 1.

The transmission coil 2 and the main receiving coil 3 can be arranged in contact with each other or at a distance from each other.

In the housing 1, above the main receiving coil 3 is placed the additional receiving coil 4, made in an identical Latin letter D shape, but smaller in size. The main receiving coil 3 and the additional receiving coil 4 lie in a plane parallel to the plane in which the transmission coil 2 lies and are in inductive balance with the transmission coil 2. The receiving coils 3 and 4 can also be arranged in different planes.

The proposed design allows the implementation of different variants, expressed in the use of a housing with different shapes, coils with different winding forms, using different shaped conductors, as well as different arrangement of the transmitting and the receiving coils—with overlap, with contact, at a distance from each other, including combinations of the listed features, all aimed at achieving induction balance of the transmitting and the two receiving coils, which affects the sensitivity of the search coil when detecting metal objects of different sizes and at different depths.

1. Coil for multi-frequency metal detector, comprising a housing with a transmitting coil and a main receiving coil, made in the shape of the Latin letter D and arranged with partial overlap, characterized with an additional receiving coil placed in the housing /4/, as the two receiving coils /3, 4/ lie in one plane, where the additional receiving coil /4/ is smaller than the main receiving coil /3/ and is made with a shape identical to the shape of the main receiving coil /3/. Each receiving coil /3, 4/ is in inductive balance with the transmitting coil /2/.

2. Coil according to claim 1, is characterized in that the receiving coils can lie in different planes, in contact or at a distance of up to 100 mm.

3. Coil according to claim 1, is characterized in that the receiving coils /3,4/ can be from 2 to 6 pcs.

4. Coil according to claim 1, is characterized in that the transmitting coils /2/ can be from 1 to 3 pcs.

5. Coil according to claim 1, is characterized in that the transmitting coils /2/ are wound in a spiral.

6. Coil according to claim 1, is characterized in that the shape of the search coil housing can be a circle, ellipse, rhombus, square or other polygon.

7. Coil according to claim 1, is characterized in that the dimensions of the housing can be from 100 to 2000 mm.

8. Coil according to claim 1, is characterized in that the search coil can work with a metal detector operating at frequencies from 2 to 200 pcs. of frequencies.

9. Coil according to claim 1, is characterized in that the shape of the coils can be in the shape of the Latin letter D, ellipse, circle, rhombus or polygon.

10. Coil according to claim 1, is characterized in that the operating frequency of the search coil is from 500 Hz to 100 kHz.

11. Coil according to claim 1, is characterized in that the transmitting coils /2/ can be 2 or 3 pieces of the same size and shape, arranged one on top of the other, touching or at a distance of up to 100 mm from each other.

12. Coil according to claim 1, is characterized in that the transmitting coils /2/ can from 2 to 6 pieces, arranged one inside the other, lying in one plane or in parallel planes at a distance of up to 100 mm from each other.
